(19) United States
(12) Patent Application Publication
(10) Pub. No.: US 2005/0103320 A1
(43) Pub. Date: May 19, 2005

(54) Reciprocating wire saw

(76) Inventor: Walter Ebner, Duluth, GA (US)

Correspondence Address: GEORGE R. REARDON, 3356 STATION COURT, LAWRENCVILLE, GA, 30044, US

(21) Appl. No.: 10/982,088

(22) Filed: Nov. 5, 2004

(30) Foreign Application Priority Data
Nov. 18, 2003 (SE) 01972/03

(51) Int. Cl. B28D 1/08

(52) U.S. Cl. 125/21

(57) ABSTRACT

A diamond wire saw exhibits a disc fitted with a groove. The diamond wire is wound around a supply reel activated by a first motor placed close to the centre of the disc. The diamond wire then passes over a pulley, then into the groove of the disc. The diamond wire moves away from the disc in a loop passing through two pulleys between which is placed the part to be sawn. The diamond wire then passes through a tension pulley, then returns to a pulley placed on the disc, and from there to the groove, then to a take-up reel placed close to the centre of the disc, symmetrically to the supply reel. The disc oscillates, communicating a to and fro motion to the wire. At each oscillation, a motor placed on the disc and controlled by approach switches depending on the angular position of the disc, makes the supply reel turn at a certain angle, freeing a certain length of wire. Likewise, the take-up reel turns at a certain angle and winds a certain length of used wire each time that the tension pulley reaches a determined position. The wire is thereby continually replaced during sawing.

Claim is hereby made for the benefit of Swiss Application No.01972/03 filed Nov. 18, 2003.

### BACKGROUND OF THE INVENTION

Precision diamond wire saws have been around for decades. They work on a reciprocating system, i.e. a diamond wire of a set length is continually wound and unwound. These saws work slowly but very precisely, and the work-piece is not exposed to any heat.

For some while, one has been able to find so-called “endless diamond wire” saws on the market, which work on the same principle as band saws, i.e. the wire is welded and forms a closed loop. These saws work at high speed and as such produce heat, which, however, in certain cases, does not have any significant consequences. The manufacture of small diameter (smaller than 0.3 mm) welded diamond wires is difficult and consequently they cannot be considered for use in numerous applications. Furthermore, for diamond wires of less than 0.1 mm diameter, the reciprocating system is not satisfactory either, since the diamond wire breaks frequently, each time entailing the loss of 10 m. of diamond wire.

It is not only essential to use less diamond wire, but also to reduce the time spent fitting new diamond wire on to the saw.

Furthermore, very hard materials such as sapphire, silicon carbide (SiC), etc. have a very pronounced wearing effect on the diamonds found along the wire, which are only slightly harder than the part to be cut (on the Moh hardness scale: diamonds=10, sapphire=9). This results in incalculable cutting times, which can appear as follows: 1st cut=20 min., 2nd cut=2 h., 3rd cut=18 h. The reason for this is that the edges of the diamonds become rounded and this wear can only be partially offset by increased pressure. However, it very difficult to produce greater pressure in the case of fine diamond wire. The best solution by far consists in the process described herein, which allows a new diamond wire to be added as needed.

One object of the present invention is to provide a reciprocating diamond wire saw which can use a very fine diamond wire and which makes it possible to avoid the loss of significant lengths of diamond wire in case of breakage. Another object of the present invention is to continually replace the diamond wire during the sawing, so as to ensure sawing times that are as consistent as possible.

The invention is defined in the claims.

### BRIEF DESCRIPTION OF THE SEVERAL VIEWS OF THE DRAWING

The drawings represent, by way of example, two embodiments of the invention, in simplified form.

FIG. 1 is a diagrammatic front view of a saw in an initial embodiment of the invention.

FIG. 2 is a diagrammatic rear view of a saw in a second embodiment of the invention.

FIG. 3 is a vertical section of a saw according to FIG. 2.

FIG. 4 is a side view of a take-up reel that can be used in a saw according to the invention.

FIG. 5 is a front view of a reel according to the embodiment in FIG. 4.

FIG. 6 is a cross section according to A-B of a take-up reel according to the embodiment in FIG. 4 and FIG. 5.

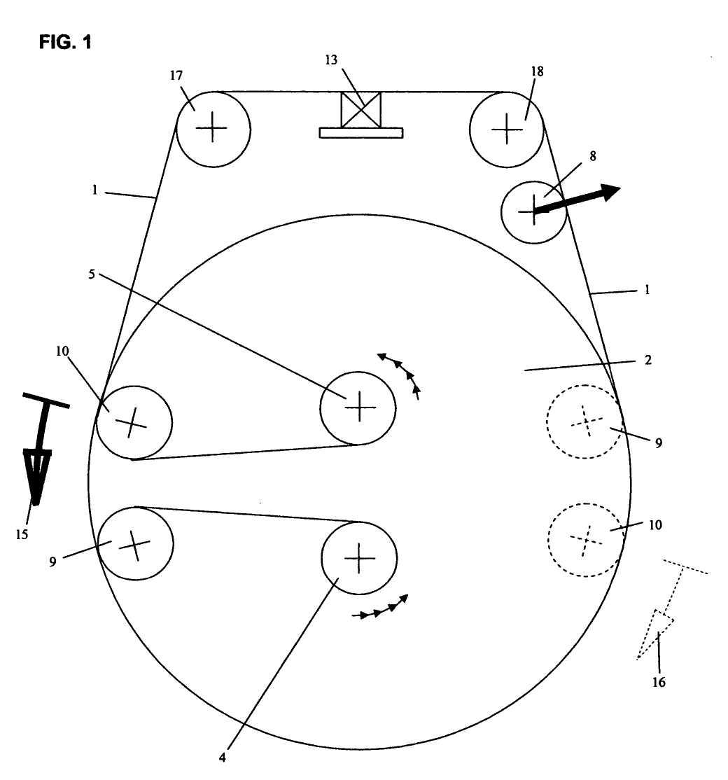

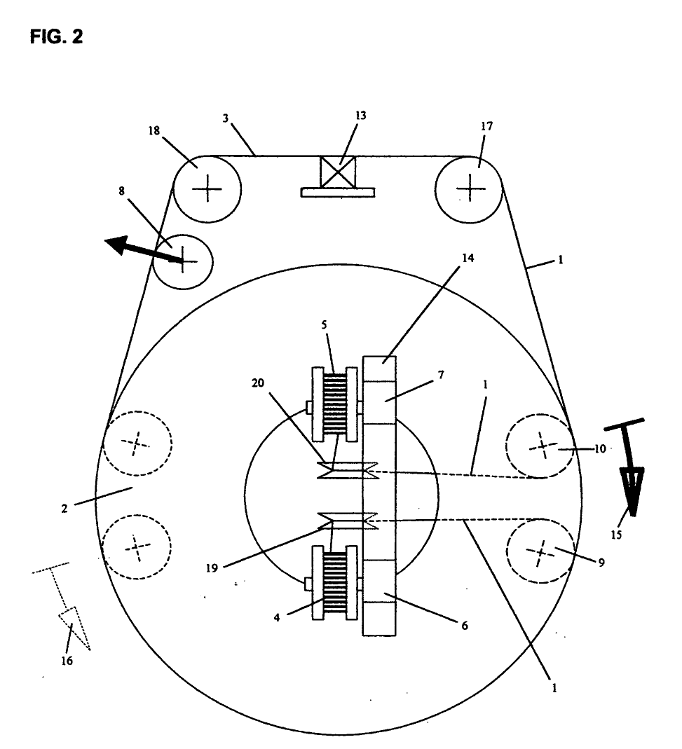

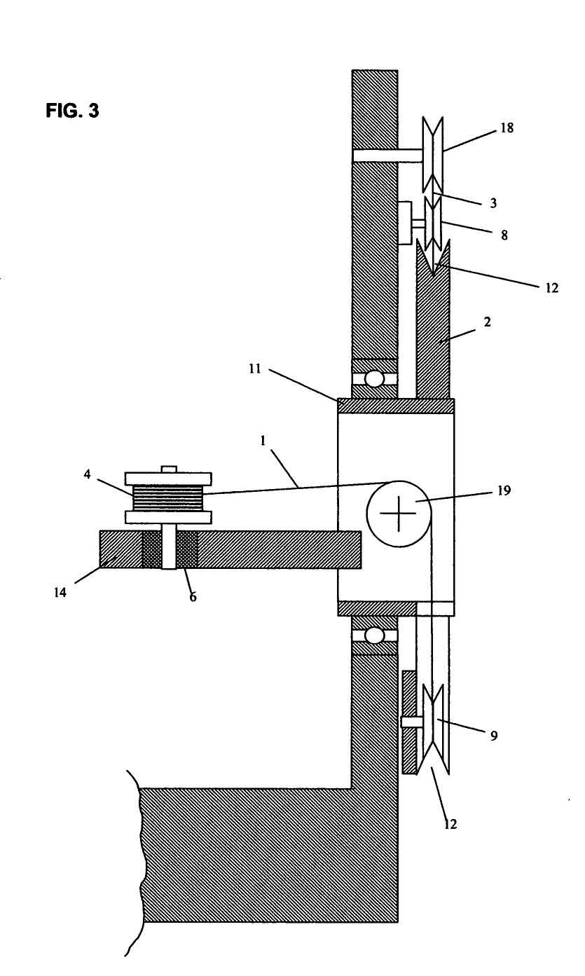

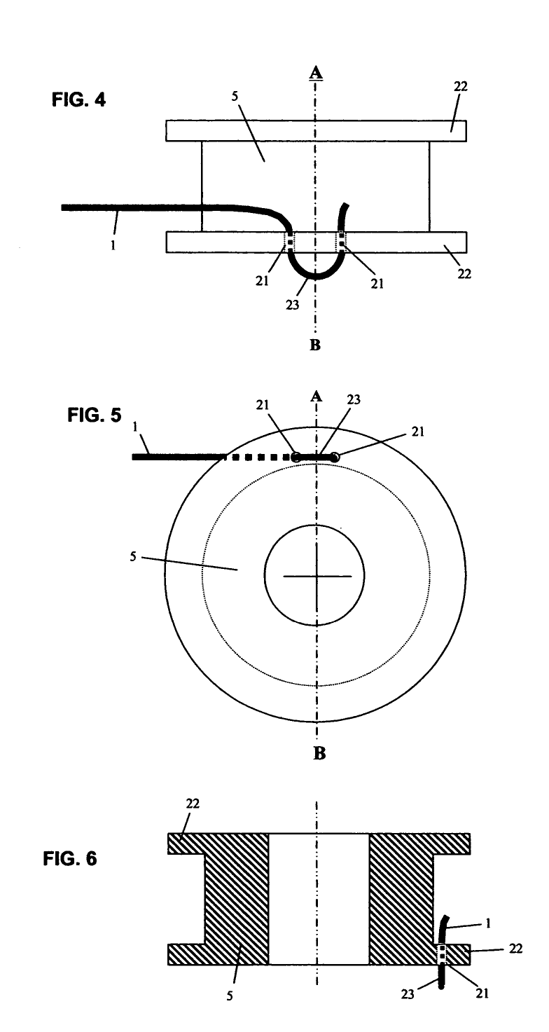

It should be noted that FIG. 1 and FIG. 2 do not show the support on which the saw is mounted and that, in the 3 figures, the means for operating the saw (motors, gears, etc.) are not represented, likewise certain secondary equipment.

### DETAILED DESCRIPTION OF THE INVENTION

The reciprocating wire saw according to the invention has at least one disc 2. The periphery of the disc is fitted with a groove 12 (not represented in FIG. 1 and FIG. 2). The diamond wire 1 is inserted in this groove 12.

The diamond wire 1 encircles the lower part of the disc 2 over slightly more than 180°. The diamond wire 1 runs from a drum serving as a supply reel 4, placed close to the centre of the disc 2. It then moves towards a pulley 9 (summarily represented in the drawings by a simple circle, like the other pulleys) placed on the periphery of the disc 2. From there, the diamond wire 1 passes into the groove 9 set in the periphery of the disc 2, then continues away from the disc 2 in a loop 3, guided by two pulleys 17 and 18 placed on either side of the support holding the part to be sawed 13. The diamond wire 1 is thereby stretched horizontally above the part to be sawed 13. The two pulleys 17 and 18 must be placed as close as possible to the part to be sawed 13. This part to be sawed 13 is placed on a support that can be adjusted height-wise and horizontally, for example, by means of micrometer screws. The support is summarily represented in the drawings by a simple rectangle. The diamond wire 1 then passes through a tension pulley 8, which ensures the diamond wire 1 has a relatively constant tension by moving under the action, for example, of a spring (not represented in the drawings). The direction of the pressure exercised on the diamond wire 1 by the pulley 8 is indicated in the drawings by an arrow. The diamond wire 1 then moves back into the groove 12, and passes into a pulley 10 placed on the periphery of the disc 2, very close to the pulley 9, and turning in the same direction. From there, the diamond wire 1 runs towards a take-up reel 5, which turns in the opposite direction from the supply reel 4. The supply reel 4 and take-up reel 5 are controlled by one or more motors 6 and 7. It is theoretically possible to control these two elements with a single motor 6 (for example, by way of gears and clutch mechanisms, so as to ensure an independent control for each element), but it is preferable to place a motor on each of these elements. It is the latter solution that is represented in the drawings.

At each oscillation of the disc, the diamond wire 1 moves along a distance which naturally depends on the angle of rotation made by the disc. In FIG. 1 and FIG. 2 the rotation of the disc is symbolised by the two arrows going in the opposite direction 15 and 16, the first arrow 15 drawn in bold, represents the “to” movement and the arrow drawn in dotted lines is the “from” movement. In FIG. 1, the two pulleys 9 and 10 appear in solid lines on the left in their starting position, and on the right in dotted lines in their opposite position, at the end of the oscillation of the disc. Similarly, in FIG. 2, these two pulleys 9 and 10 appear in thick dotted lines in their starting position, on the right, and in finer dotted lines in their opposite position, on the left.

In the embodiment represented in FIG. 1 and FIG. 2, the amplitude of the movement of the disc 2 can hardly exceed 180°. It suffices to increase the diameter of the disc in relation to that of the wire-guide pulleys 17 and 18 placed on either side of the part to be sawed 13, and/or to reduce the distance between these two pulleys 17 and 18, to increase the possible amplitude of the rotation of the disc 2 and, consequently, the usable length of the diamond wire 1 at each oscillation.

The two motors 6 and 7 control the rotation of the supply reel 4 and the take-up reel 5 respectively (by means of reducing gears not represented in the drawings). The rotation of these motors is servo-controlled. Thus, on each travel, an adjustable quantity of new diamond wire 1 is distributed by the rotation of the supply reel 4 driven by the motor 6, depending on the angular position of the disc 2. As for the motor 7, its rotation is controlled by the movement of the diamond wire 1 through tension pulley 8, i.e. the used diamond wire 1 is rewound when the diamond wire 1 length is too long and the wire tension pulley 8 moves too far away from a determined position. The low amplitude and repeated angular movement of the supply reel 4 and the take-up reel 5 are represented in FIG. 1 by the small arrows placed end to end in an arc of a circle. The approach switches (proximity detectors) provide the switching functions. In addition to the wire tension pulley 8, two wire guide pulleys are used, which are fixed near to the part to be sawed 13 and which must be placed as closely as possible to this part to be sawed 13.

In the embodiment in FIG. 1, the motors 6 and 7 are hidden behind the supply reel 4 and behind the take-up reel 5 respectively. The supply reel 4 and take-up reel 5, as well as the motors 6 and 7 which drive them, are therefore mounted directly on the disc 2. This embodiment is the simplest.

In the embodiment in FIGS. 2 and 3, the supply reel 4 and take-up reel 5, as well as the motors 6 and 7, are mounted behind the disc 2, on a plate 14 which is itself fixed on a hollow spindle 11 placed in the centre of the disc 2. The diamond wire 1 is sent back to the pulleys 9 and 10 by means of additional pulleys 19 and 20, passing through the hollow spindle 11. Although this construction is more complicated, it has the advantage of allowing the use of a larger diameter supply reel 4 and take-up reel 5, and consequently of a greater length of diamond wire 1.

In case of diamond wire 1 breakage, the take-up reel 5 can easily be removed from its drive pin, on which it is fixed in a removable fashion according to classical means not represented here. The already partially or totally used diamond wire 1 strand, which is attached to it, is removed with it. A new take-up reel 5 is fixed in its place. The take-up reel 5 exhibits two openings 21 made in the wall 22 of the take-up reel 5. The end of the remaining diamond wire 1 coming from the supply reel 4 is introduced into one of these two openings. The diamond wire 1 protrudes outside and is reintroduced into the second opening 21. In this way it forms a loop 23, and the diamond wire 1 is solidly fixed. Once the take-up reel 5 is put in place on its drive pin and the diamond wire 1 is put back in position in the various pulleys that move it, the saw can be started again. The changeover is carried out rapidly. There is hardly any loss of time and it is thus possible to use the rest of the diamond wire 1 without having to throw away the whole length.

Other means of fixing the diamond wire 1 on the take-up reel 5 are possible.

1. A reciprocating diamond wire saw, comprising a diamond wire and at least one oscillating disc on the periphery of which is fitted at least one groove in which is inserted a part of said diamond wire, wherein another part of the wire forms a loop by moving away from said oscillating disc, wherein said loop enters into contact with the part to be sawn, wherein the reciprocating motion is given to said loop by the inversion of the direction of rotation of the disc, characterised in that a part of said diamond wire is wound around a supply reel, and in that another part of said diamond wire is wound around a take-up reel, and in that a first motor turns said supply reel in such a way as to continuously or intermittently unwind the wire and in that a second motor makes said take-up reel turn in such a way as to continuously or intermittently wind said diamond wire, wherein said loop is placed downstream from said supply reel and upstream from said take-up reel and thereby being regularly and gradually replaced during the cutting process.

2. The reciprocating diamond wire saw according to claim 1, further comprised in that said diamond wire is guided from said supply reel to the periphery of said disc by means of at least one pulley.

3. The reciprocating diamond wire saw according to claim 2, further comprised in that said diamond wire is guided from the periphery of said disc to said take-up reel by means of at least one pulley.

4. The reciprocating diamond wire saw according to claim 3, wherein said reciprocating diamond wire saw is further comprised of at least one wire tension pulley, the means to press the said wire tension pulley in the direction of said loop, and a mechanism able to start said second motor controlling the rotation of said take-up reel depending on the position of the said wire tension pulley.

5. The reciprocating diamond wire saw according to claim 4, wherein said reciprocating diamond wire saw is further comprised of a mechanism able to start said first motor controlling the rotation of said supply reel depending on the angular position of said disc.

6. The reciprocating diamond wire saw according to claim 5 wherein said reciprocating diamond wire saw is further comprised of approach switches proximity detectors that control said first motor and said second motor.

7. The reciprocating diamond wire saw according to claim 6, wherein said supply reel is fixed on said disc.

8. The reciprocating diamond wire saw according to claim 7, wherein said take-up reel is fixed on said disc.

9. The reciprocating diamond wire saw according to claim 8, wherein said first motor activating said supply reel is fixed on said disc.

10. The reciprocating diamond wire saw according to claim 9, wherein said second motor activating said take-up reel is fixed on said disc.

11. The reciprocating diamond wire saw according to claim 6, wherein said reciprocating diamond wire saw is further comprised in that said supply reel and take-up reel are fixed behind the disc, and wherein said diamond wire passes over the front face of said disc through a hollow spindle.
